(19) United States
(12) Patent Application Publication
(10) Pub. No.: US 2025/0187458 A1
(43) Pub. Date: Jun. 12, 2025

(54) STATIONARY FLOOR ASSEMBLY FOR AN INDUCTIVE CHARGING DEVICE

(71) Applicant: MAHLE International GmbH, Stuttgart (DE)

(72) Inventors: Thomas Himmer, Reichenbach (DE); Holger Schroth, Maulbronn (DE); Martin Steinbach, Waiblingen (DE)

(21) Appl. No.: 18/847,220

(22) PCT Filed: Mar. 10, 2023
(86) PCT No.: PCT/EP2023/056100

§ 371 Date: Sep. 13, 2024

(30) Foreign Application Priority Data
Mar. 14, 2022 (DE) 10 2022 202 488.5

(51) Int. Cl. B60L 53/12; H02J 50/00; H02J 50/10

(52) U.S. Cl. CPC B60L 53/12; H02J 50/005; H02J 50/10

(57) ABSTRACT

A stationary underbody assembly for an inductive charging device for inductive charging of a motor vehicle is disclosed. The stationary underbody assembly includes a housing with a base plate and a housing cover covering the base plate. A flat coil held by a strand carrier, which has a spirally wound conductor and is spaced from the base plate along a spacing direction. A core arrangement with at least one core body for magnetic flux guidance. A cavity formed between the at least one core body and the base plate. A support provided between the flat coil and the base plate. The strand carrier has a pressure platform. A load distribution structure is arranged between the housing cover and the strand carrier.

### CROSS-REFERENCE TO RELATED APPLICATIONS

This application claims priority to International Patent Application No. PCT/EP2023/056100 filed Mar. 10, 2023, which also claims priority to German Patent Application No. DE 10 2022 202 488.5 filed on March 14. 2022, the contents of each of which is hereby incorporated by reference in its entirety.

### TECHNICAL FIELD

The present invention relates to a stationary underbody assembly for an inductive charging device for inductive charging of a motor vehicle.

### BACKGROUND

In the case of at least partially electrically powered vehicles, regular charging of the vehicle's electrical energy storage system is necessary. In principle, a direct electrical connection can be established between the vehicle and an external electrical energy source, such as a power connection. However, this requires manual action by a user.

It is also known to charge the vehicle, i.e. in particular the electrical energy storage unit, inductively. In a stationary underbody assembly outside the vehicle, there is a primary coil that interacts inductively with a secondary coil (“vehicle assembly”) in the vehicle in order to charge the energy storage unit.

When the charging device is in operation, the vehicle to be charged can drive over the underbody assembly, which can lead to damage to the underbody assembly, at least in the long term, if the load-bearing capacity is too low.

The present invention therefore deals with the problem of providing an improved or at least different embodiment for a stationary underbody assembly of the type according to the present invention, which in particular has a higher load-bearing capacity.

According to the invention, this problem is solved by the subject matter of independent claim(s). Advantageous embodiments are the subject of the dependent claims.

### SUMMARY

The present invention is based on the general idea of increasing the mechanical load-bearing capacity of a stationary underbody assembly for an inductive charging device by means of special pressure platforms on a strand carrier, over which a spirally wound conductor of a flat coil is held. The stationary underbody assembly according to the invention for an inductive charging device for inductive charging of a motor vehicle parked on a surface has a housing with a base plate and a housing cover covering the base plate, wherein the base plate extends transversely to a spacing direction in the shape of a plate. An installation space is provided in the housing, in which at least one flat coil held by a strand carrier is arranged with the aforementioned spirally wound conductor. The strand carrier and the flat coil are arranged along the spacing direction between the base plate and the housing cover. Also provided is a core arrangement with at least one core body, for example a ferrite plate, for magnetic flux guidance, which is arranged along the spacing direction between the base plate and the flat coil and extends transversely to the spacing direction in the form of a plate. A cavity is arranged between the at least one core body, for example a ferrite plate, and the base plate, through which a support extends along the spacing direction. The support rests on the base plate on the underbody side and carries the flat coil with the wound conductor and the strand carrier. The strand carrier itself has a pressure platform via which a load distribution structure, for example a load plate arranged between the housing cover and the strand carrier, is supported directly or indirectly on an associated support. The pressure platform, which is preferably arranged at least approximately, in particular even completely, aligned in the spacing direction, also with regard to the two-dimensional cross-sectional expansions to the respective support arranged underneath, can achieve an improved load transfer of a motor vehicle driving on the housing cover, in that the type of load in the endangered components of the strand carrier or flat coil and core arrangement is largely uniaxial as normal compressive stress, which significantly reduces the risk of failure in said components and in the other load-transmitting components. The load distribution structure is preferably designed in such a way that it enables support in all conceivable operating states exclusively via the pressure platforms or other supports in the base plate. This means that even if the load distribution structure deflects, there is no contact between it and the strand carrier outside the pressure platform or pressure platforms, which means that there is no risk of damage to the strand carrier or the flat coil or the core arrangement arranged underneath it if the stationary underbody assembly is driven over by a motor vehicle. The pressure platforms face the load distribution structure. Usually, several such pressure platforms are provided, for example along the spacing direction in each case associated with a support arranged underneath, whereby a close-meshed support of the load distribution structure and thus a low deflection of the load distribution structure can be achieved.

In an advantageous further development of the stationary underbody assembly according to the invention, the strand carrier is supported directly on an associated support via a spacer plate. This offers the great advantage that the core arrangement and its core body remain unloaded regardless of the respective load of a motor vehicle driving over the stationary underbody assembly. In this case, the core bodies are located at a distance from the respective support transverse to the spacing direction, wherein the support is arranged transverse to the spacing direction in a central area of the flat coil and therefore does not or only marginally obstruct a magnetic field generated by the flat coil. With such an arrangement, it is even possible to make the respective support at least partially out of metal, whereby both a high load-bearing capacity and a high thermal conductivity and thus improved cooling of the flat coil can be achieved.

Alternatively, it is of course also conceivable that the strand carrier is supported on the associated support via a spacer plate and a core body. Since in this case the core body shields the support from the magnetic field, it is also conceivable in this embodiment that the support is at least partially made of a metal.

In another advantageous embodiment, the strand carrier has support platforms via which it is supported on the spacer plate. In this case, the strand carrier can therefore be open from below and have receptacles in which the respective conductor of the flat coil is inserted, for example even clipped in. The support platforms allow the strand carrier to be evenly supported on the spacer plate, wherein a lower surface pressure can be achieved with an increasing number of support platforms. The strand carrier can have a grid-like structure and thus be comparatively rigid.

At least one pressure platform is conveniently formed in one piece with the strand carrier. This offers the great advantage that the respective pressure platform and the strand carrier can be designed as a one-piece plastic injection-molded part, for example, and can therefore be manufactured both cost-effectively and to a high quality. Alternatively, it is of course also conceivable that at least one pressure platform is formed separately from the strand carrier and is connected to the strand carrier in a form-fit, for example clipped or screwed, and/or in a material-fit, for example bonded or welded. In this case, it is therefore conceivable to design the pressure platform from a different material than the strand carrier. A pressure platform of this type, which is separate from the strand carrier, can be supported on the strand carrier or reach through it, allowing direct support of the load distribution structure via the pressure platform and the spacer plate or, if applicable, the core body on the support.

In another advantageous embodiment, the pressure platform is made of plastic, in particular an elastomer with a Shore A≥50 and/or a modulus of elasticity of E_{D}≤5,000 MPa. This type of plastic enables a comparatively homogeneous pressure distribution over a platform surface of the pressure platform and thus a comparatively uniform load transfer into either the spacer plate or the strand carrier. Alternatively, it is of course also conceivable that the pressure platform is made of ceramic. It is only important that the pressure platform or the strand carrier are made of a material that does not or only marginally influence the power transmission of an alternating electromagnetic field generated by the flat coil or the core arrangement.

In a further advantageous embodiment of the solution according to the invention, the load distribution structure is designed as a plate made of plastic, in particular with a modulus of elasticity of E_{L}≥10 GPa. The material of choice here is a plastic, in particular polyamide (PA), polyoxymethylene (POM), polyphenylene sulphide (PPS), polyether ether ketone (PEEK).

The load distribution structure is conveniently designed as a plate made of fiber-reinforced plastic, in particular glass fiber-reinforced plastic. Glass fiber-reinforced plastics in particular have significantly increased strength and a significantly higher modulus of elasticity. Short fibers, long fibers and continuous fibers can be used here, for example. Glass fibers also offer the great advantage that they do not influence an alternating electromagnetic field.

In a further advantageous embodiment of the solution according to the invention, an air flow path leads through the cavity so that, for example, an electronic component arranged therein can be cooled by means of an air flow. Since the supports for supporting the core arrangement or the strand carriers and the load distribution structure are also located in the cavity, the flat coils can also be cooled indirectly by cooling the supports. The core bodies of the core arrangement are arranged in the cavity and the air flow path and can also be cooled by the cooling air flowing there, for example. Such cooling increases the performance of the stationary underbody assembly. A further increase is possible, for example, by providing cooling channels for a coolant in the base plate, whereby the base plate and thus also the cavity above it and the supports can be actively cooled.

In a particularly advantageous embodiment of the solution according to the invention, the housing cover is supported on the base plate via housing supports. These housing supports surround the cavity and can also be used for load transfer. However, the main load transfer when a motor vehicle drives over the stationary underbody assembly according to the invention takes place via the load distribution structure, such as the pressure platform and the supports.

The load distribution structure can, for example, rest on the brackets of the housing supports and thus be held by them in a form-fit. Additionally or alternatively, the load distribution structure can be connected to at least one housing support, for example bonded, welded or screwed. This makes it comparatively easy to remove the load distribution structure while at the same time removing the housing cover from the base plate. In addition, the load distribution structure can also be connected to the underside of the housing cover, for example welded, glued or screwed.

At least one further support is conveniently provided, via which the load distribution structure is supported directly on the base plate. This makes it possible to provide support outside the pressure platforms without placing any load on the core arrangement or the flat coil.

Further important features and advantages of the invention are apparent from the sub-claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus or an arrangement, which are designated separately, can form separate parts or components of this unit or be integral areas or sections of this unit, even if this is shown differently in the figures.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

It shows, in each case schematically,

FIG. 1 a sectional view of a first possible embodiment of a stationary underbody assembly according to the invention,

FIG. 2 a representation as in FIG. 1, but in a different embodiment,

FIG. 3 a detailed sectional view of a pressure platform formed in one piece with a strand carrier,

FIG. 4 a representation as in FIG. 3, but with a separate pressure platform,

FIG. 5 a representation as in FIG. 4, but with a continuous pressure platform,

FIG. 6 a view from below of a strand carrier with an inserted flat coil,

FIG. 7 a section of the strand carrier with flat coil viewed from above,

FIG. 8 a representation as in FIG. 7, but from an oblique view from below.

### DETAILED DESCRIPTION

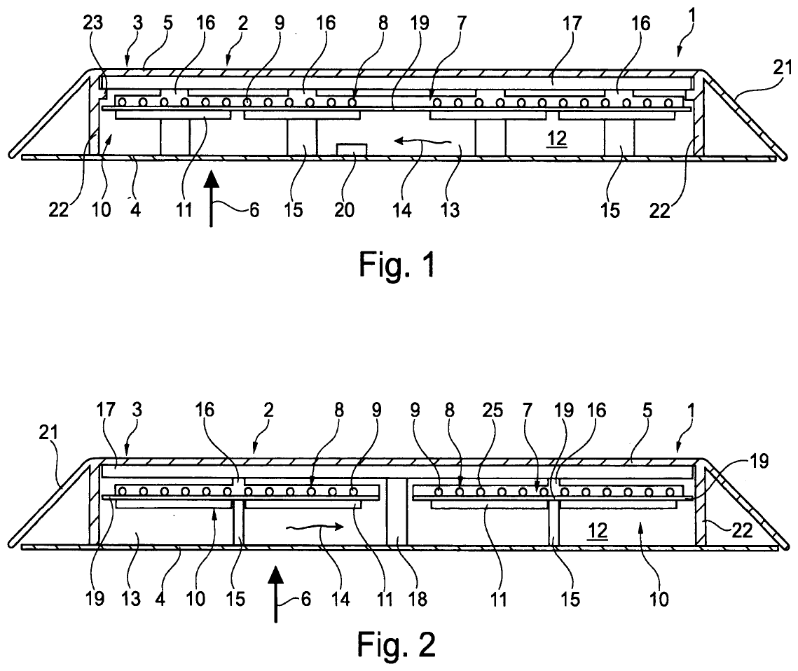

According to FIGS. 1 and 2, a stationary underbody assembly 1 according to the invention for an inductive charging device 2 for inductive charging of an unspecified motor vehicle has a housing 3 with a base plate 4 and a housing cover 5 covering the base plate 4. The base plate 4 extends transversely to a spacing direction 6, which usually corresponds substantially to a vertical line. Furthermore, at least one flat coil 8 is provided, which is held by a strand carrier 7, has a spirally wound conductor 9 and is arranged at a distance from the base plate 4 along the spacing direction 6, i.e. lying above it. Furthermore, a core arrangement 10 is provided with at least one core body 11, for example a ferrite plate, for magnetic flux guidance, which is spaced apart from the base plate 4 and the flat coil 8 along the spacing direction 6 and is thus arranged between the base plate 4 and the conductor 9 of the flat coil 8 and extends transversely to the spacing direction 6. A cavity 12 is formed between at least one core body 11, for example a ferrite body, and the base plate 4, through which, for example, an air flow path 13 is routed, through which cooling air 14 can flow. In addition, at least one electronic component 20 can be arranged in the cavity 12, which can be additionally cooled by the cooling air 14 flowing in the air flow path 13.

At least one support 15 is provided between the flat coil 8 and the base plate 4, which extends through the cavity 12 along the spacing direction 6. The strand carrier 7 also has at least one pressure platform 16, wherein a load distribution structure 17, for example a load distribution plate, is arranged between the housing cover 5 and the strand carrier 7, which is supported on the at least one pressure platform 16 and via this on the associated support 15 arranged underneath along the spacing direction 6.

The stationary underbody assembly 1 according to the invention offers the great advantage that when a load is applied from above, for example by a motor vehicle driving over the stationary underbody assembly 1, a load is applied exclusively via the pressure platforms 16 via the strand carrier 7 or the supports 15 arranged underneath, but a direct load application from the load distribution structure 17 into the flat coil 8, even in the event of deflection, can be reliably avoided, which in particular can prevent damage. As can be seen from FIGS. 1 and 2, a large number of such pressure platforms 16 are provided with supports 15 arranged underneath along the spacing direction 6, which enables a comparatively homogeneous support of the load distribution structure 17 and thus also a low deflection of the same.

In addition, as shown in FIG. 2, the load distribution structure 17 can also be supported directly on the base plate 4 via a further support 18. If such additional supports 18 are used, the pressure platforms 16 and the supports 15 can generally be made smaller, in particular slimmer.

Looking further at FIG. 1, it can be seen that the strand carrier 7 is supported on an associated support 15 via a spacer plate 19 and a core body 11, while according to FIG. 2 the strand carrier 7 is supported directly on an associated support 15 via the spacer plate 19. The advantage of the embodiment shown in FIG. 2 is in particular that the core bodies 11 of the core arrangement 10 are not loaded, regardless of the load acting from above.

In addition to lateral slopes 21, the housing cover 5 also has housing supports 22, via which the housing cover 5 is supported on the base plate 4. The housing supports 22 can also have brackets 23 (see FIG. 1), so that according to FIG. 1 the load distribution structure 17, for example the load distribution plate, can be held in a form-fit between the housing cover 5 and the brackets 23. At least a slight load support of the load distribution structure 17 is therefore also possible via the brackets 23 and the housing supports 22 in the base plate 4.

The load distribution structure 17 can be firmly connected to at least one housing support 22, a bracket 23 and/or the housing cover 5, for example glued, welded or screwed. In particular, this allows the load distribution structure 17 to be removed at the same time as the housing cover 5.

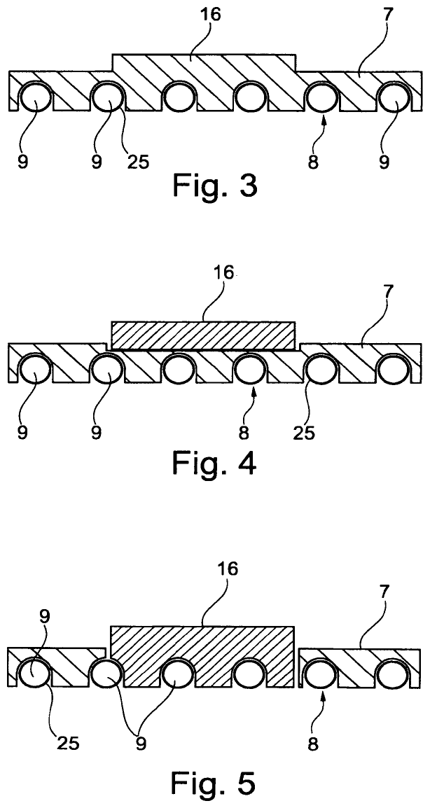

If we take a closer look at the pressure platforms 16 shown in FIGS. 3 through 5, we can see a wide variety of embodiments. According to FIG. 3, for example, a strand carrier 7 is shown which is formed integrally with the pressure platform 16, so that in this case the pressure platform 16 and the strand carrier 7 are formed in one piece.

As shown in FIG. 4, the pressure platform 16 is designed separately from the strand carrier 7 and is only held in a form-fit in a recess in the strand carrier 7. Of course, in addition to the pure form-fit mounting, the pressure platform 16 can also be bonded to the strand carrier 7.

According to FIG. 5, the pressure platform 16 is also separate from the strand carrier 5, but extends completely through the strand carrier 5, whereby a direct load transfer takes place from the load distribution structure 17 via the pressure platform 16 into the spacer plate 19 and from there either into the core body 11 and the support 15 according to FIG. 1 or directly into the support 15 according to FIG. 2. In the embodiment shown in FIG. 5, the pressure platform 16 can also be connected to the strand carrier 7 not only in a form-fit, but also in a material-fit, for example by bonding or screwing.

The pressure platform 16 and the strand carrier 7 are preferably made of a plastic, for example an elastomer with a Shore A hardness of ≥50 and/or a modulus of elasticity of E_{D}≤5,000 MPa. Plastic materials such as EPDM (ethylene propylene diene (monomer) rubber) or polypropylene (PP) can be used here. The load distribution structure 17, in turn, should be very rigid and have a high strength in order to limit deflection of the load distribution structure 17 even when the load distribution structure 17 is driven over between two supports 15 in such a way that contact between the load distribution structure 17 and the strand carrier 7 does not occur under any load state. In order to further increase the strength and also the rigidity of the load distribution structure 17, it can also be fiber-reinforced, in particular glass fiber-reinforced. In theory, other fibers, such as aramid fibers, are of course also possible.

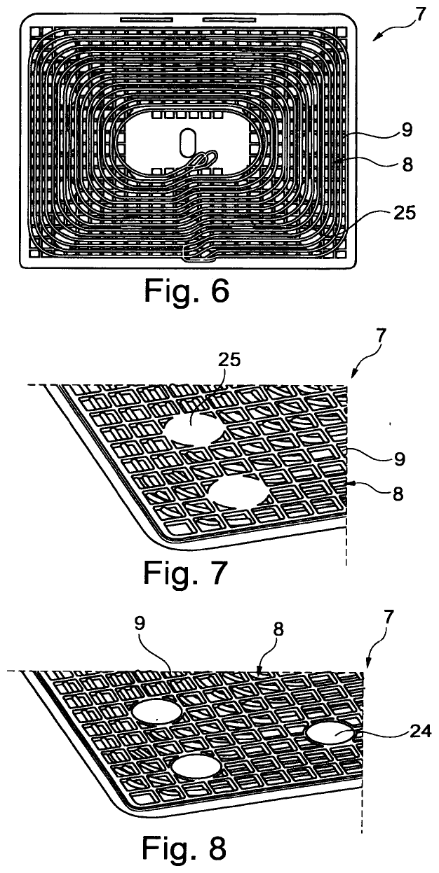

If you look at the strand carriers 7 as shown in FIGS. 6 through 8, you can see that they have support platforms 24, via which the strand carrier 7 is supported on the spacer plate 19 and via which it is supported on the core body 11 or directly on the support 15. Seen from below, the support platforms 24 have receptacles 25 in which the respective conductor 9 of the flat coil 8 is guided. In the installed state, as shown in FIG. 8 for example, the pressure platform 16 (FIG. 8 upper side) supports the load distribution structure 17 and presses downwards (view FIG. 6) onto the spacer plate 19. This in turn is bonded to the core bodies 11 (ferrite plates), which in turn lie on the supports 15.

All in all, the stationary underbody assembly 1 according to the invention can achieve a significant increase in its load-bearing capacity, wherein the load distribution structure 17 and the pressure platforms 16 in particular can reliably prevent direct loading of a flat coil 8 and thus possibly also damage to the same or also to the core arrangement 10 arranged underneath. A further advantage of such an arrangement is that the pressure platforms 16 and the supports 15 are largely aligned in the spacing direction 6, which also relates in particular to the two-dimensional cross-sectional expansions of the pressure platforms 16 and the supports 15 located underneath. The pressure platform 16 and the associated support 15, which is axially aligned in the spacing direction 6, also preferably have a cross-section that is at least approximately, preferably completely, identical in terms of dimensions, shape and alignment. As a result, the type of load, in particular in the endangered components strand carrier 7 or flat coil 8 and core arrangement 10 or core body 11, is largely uniaxial as normal compressive stress in the spacing direction 6, which significantly reduces the risk of failure in the said components and in the other load-transmitting components.

Due to the fact that both the strand carrier 7 and the respective pressure platforms 16 and the load distribution structure 17 and the housing cover 5 are made of an electromagnetically neutral material, for example plastic or ceramic, the power transmission of an alternating electromagnetic field generated by the flat coil 8 and the associated core bodies 11 is not or only marginally impaired.

1. A stationary underbody assembly for an inductive charging device for inductive charging of a motor vehicle, comprising:
a housing with a base plate and a housing cover covering the base plate, wherein the base plate extends in the form of a plate transversely to a spacing direction,
at least one flat coil held by a strand carrier, which has a spirally wound conductor and is spaced from the base plate along the spacing direction,
a core arrangement with at least one core body for magnetic flux guidance, the core arrangement arranged along the spacing direction between the base plate and the conductor and extends in the form of a plate transversely to the spacing direction,
wherein a cavity is formed between the at least one core body and the base plate,
at least one support provided between the flat coil and the base plate, the at least one support extends through the cavity along the spacing direction,
wherein the strand carrier has a pressure platform, and
wherein a load distribution structure is arranged between the housing cover and the strand carrier, the load distribution structure supported on the pressure platform and via the pressure platform on the at least one support.

2. The stationary underbody assembly according to claim 1, wherein:
the pressure platform is arranged axially along the spacing direction at least approximately in alignment with the at least one support, and
the pressure platform and the at least one support, which is axially aligned in the spacing direction, have a cross-section which is at least approximately identical in terms of dimensions, shape and alignment.

3. The stationary underbody assembly according to claim 1, wherein:
the strand carrier is supported directly on an associated support via a spacer plate, or
the strand carrier is supported on the at least one support via a spacer plate and a core body.

4. The stationary underbody assembly according to claim 1, wherein at least one further support is provided, via which the load distribution structure is supported directly on the base plate.

5. The stationary underbody assembly according to claim 1, wherein:
the pressure platform is formed in one piece with the strand carrier, or
the pressure platform is formed separately from the strand carrier and is connected to the strand carrier in a form-fit and/or in a material-fit.

6. The stationary underbody assembly according to claim 5, wherein the pressure platform is separate from the strand carrier and the pressure platform reaches completely through the strand carrier.

7. The stationary underbody assembly according to claim 1, wherein the pressure platform is composed of plastic.

8. The stationary underbody assembly according to claim 1, wherein the load distribution structure is a plate composed of plastic.

9. The stationary underbody assembly according to claim 1, wherein the load distribution structure is a plate composed of fiber-reinforced plastic.

10. The stationary underbody assembly according to claim 1, wherein:
an air flow path for cooling air leads through the cavity, and/or
at least one electronic component is arranged in the cavity.

11. The stationary underbody assembly according to claim 1, wherein the housing cover is supported on the base plate via housing supports.

12. The stationary underbody assembly according to claim 11, wherein the load distribution structure rests on brackets of the housing supports.

13. The stationary underbody assembly according to claim 11, wherein the load distribution structure is connected to at least one of the housing supports.

14. The stationary underbody assembly according to claim 1, wherein the load distribution structure (17) is connected to the housing cover.

15. The stationary underbody assembly according to claim 1, wherein the pressure platform is composed of an elastomer with a Shore hardness≥50 and/or a modulus of elasticity ≤5,000 MPa.

16. The stationary underbody assembly according to claim 8, wherein the load distribution structure has a modulus of elasticity EL≥10 GPa.

17. An inductive charging device, comprising: a stationary underbody assembly including:
a housing with a base plate and a housing cover covering the base plate, wherein the base plate extends in the form of a plate transversely to a spacing direction,
at least one flat coil held by a strand carrier, which has a spirally wound conductor and is spaced from the base plate along the spacing direction,
a core arrangement with at least one core body for magnetic flux guidance, the core arrangement arranged along the spacing direction between the base plate and the conductor and extends in the form of a plate transversely to the spacing direction,
wherein a cavity is formed between the at least one core body and the base plate,
at least one support provided between the flat coil and the base plate, the at least one support extends through the cavity along the spacing direction,
wherein the strand carrier has a pressure platform, and
wherein a load distribution structure is arranged between the housing cover and the strand carrier, the load distribution structure supported on the pressure platform and via the pressure platform on the at least one support.

18. The inductive charging device according to claim 17, wherein:
the pressure platform is arranged axially along the spacing direction in alignment with the at least one support, and
the pressure platform and the at least one support, which is axially aligned in the spacing direction, have a cross-section which is at least approximately identical in terms of dimensions, shape and alignment.

19. The inductive charging device according to claim 17, wherein at least one further support is provided, via which the load distribution structure is supported directly on the base plate.

20. The inductive charging device according to claim 17, wherein the load distribution structure and/or the pressure platform is composed of plastic.
